(19) United States
(12) Patent Application Publication
(10) Pub. No.: US 2012/0179931 A1
(43) Pub. Date: Jul. 12, 2012

(54) DATA PROCESSING MODULE PROVIDING UNIFORM POWER CONSUMPTION FOR DIGITAL LOGIC

(75) Inventors: Alain Vergnes, Trets (FR); Guillaume Pean, Aix en Provence (FR)

(73) Assignee: ATMEL ROUSSET S.A.S., Rousset (FR)

(21) Appl. No.: 12/986,124

(22) Filed: Jan. 6, 2011

(51) Int. Cl. G06F 1/04

(52) U.S. Cl. 713/600

(57) ABSTRACT

A microcontroller that includes logic to provide a uniform overall power consumption current of parts of the microcontroller generated by sequential element switching is disclosed. For example, the number of sequential elements switching at the triggering edge of the clock is calculated to determine a number of switching elements. The number of switching elements is compared to the number of sequential elements of the circuitry. Additional sequential elements are added in the circuitry and are forced to switch so that the overall number of switching elements equals the number of sequential elements, excluding the additional sequential elements.

### TECHNICAL FIELD

This subject matter is generally related to electronics, and more particularly to microcontroller architectures that include data processing modules that provide uniform power consumption for digital logic.

### BACKGROUND

In an integrated circuit, elements, or cells, in the digital circuitry are powered by internal power supply rails in which opposite terminals (pad of the circuit) are bonded to two or more package pins. These package pins are connected to a voltage regulator on the printed circuit board by means of copper lines. It is therefore easy, for example, to insert a low value resistor between components and analyze the shape of the current consumed by the integrated circuit by storing the voltage across the resistor. Other techniques may also be used to analyze the shape of the current while still being non-intrusive to the integrated circuit. Careful analysis of the current may help to extract secret information hidden in the integrated circuit. One important class of current analysis is called differential power analysis (DPA). DPA is based on analyzing the variations in the current over a number of clock cycles while performing any processing like, for example, cryptographic operations.

Conventional techniques for preventing accurate current analysis exist. For example, additional logic may be added to a circuit to generate a random current. Dummy or fake processing cycles may be added into the normal processing period to randomize the normal processing length to prevent external analysis from synchronizing correctly. Some conventional circuits may keep the processing logic alive by processing fake data to prevent external analysis.

### SUMMARY

A microcontroller that includes digital logic to provide a uniform overall power consumption current of parts of the microcontroller generated by sequential element switching is disclosed. For example, a number of sequential elements switching at the triggering edge of a clock can be calculated to determine the number of switching elements. The number of switching elements can be compared to the number of sequential elements of the microcontroller circuitry. Additional sequential elements are added in the microcontroller circuitry and forced to switch so that the overall number of switching elements equals the number of sequential elements, excluding the additional sequential elements.

According to implementations, the circuitry disclosed herein provides a uniform digital sequential elements switching current. This current can be easily located because its shape looks like a series of pulses and the peak value is directly linked to the number of elements switching simultaneously. Microcontroller circuits that include the additional digital logic disclosed herein may exhibit a peak current that remains close to the same value regardless of the data being processed. Therefore, there may be less leakage of information by observing current consumption patterns of the microcontroller.

Particular embodiments of the invention can be implemented to realize one or more of the following advantages: (1) the disclosed architecture provides uniform power consumption that is simple and fully synchronous; and (2) the architecture can be inserted into any existing circuits.

### DESCRIPTION OF DRAWINGS

FIG. 1 is a block diagram of an example microcontroller including a microprocessor core and various modules connected through a system bus matrix.

FIG. 2 is a block diagram of example data processing module architecture.

FIG. 3 is a block diagram of an example combinational network.

FIG. 4 is a line graph illustrating an example overall power consumption curve for the example circuitry of FIG. 2 within the microcontroller of FIG. 1.

FIG. 5 is a block diagram of an example circuit including an example current uniformization logic coupled to existing logic.

FIG. 6 is a line graph of an example overall power consumption curve for a circuit that includes current uniformization logic.

FIG. 7 is a block diagram of an example circuit including a 2-bit binary counter coupled to example current uniformization logic.

FIG. 8 is a line graph of an example overall power consumption curve for a circuit that includes current uniformization logic.

FIG. 9 is a block diagram of an example data processing module of including current uniformization logic.

FIG. 10 is a flow diagram of an example process for providing uniform power consumption in a microcontroller.

### DETAILED DESCRIPTION

### System Overview

A microcontroller includes logic to provide a uniform overall power consumption current of the microcontroller generated by sequential element switching. For example, mobile technologies, including mobile devices, and point of sale equipment require mechanisms to provide more privacy and/or security to prevent personal data recovery or hacking. Hacking may be performed with non-intrusive attacks; for example, power consumption current analysis. Microcontrollers may be manufactured to prevent successful hacking attempts by including modules having a power consumption current that is as uniform as possible thereby preventing hackers from determining the inner workings of the microcontroller by performing external analysis of the power consumption current. In digital circuits, especially the synchronous logic, all sequential elements, especially data flip-flop (DFF) elements, are triggered at the same time and therefore when several DFFs are switching, the overall current looks like a peak of current which is a sum of all DFF switching currents. Therefore, the peak of current is directly linked to the number of DFFs that are switching.

A microcontroller comprises a series of peripherals that use synchronous logic. If one of the peripherals is a data processing module where the processing is an encryption/decryption module based on a user secret key, it is important that the current shape is as uniform as possible regardless of the key or data being encrypted with the key. Maintaining a uniform current shape during encryption/decryption processing may prevent the user secret key from being discovered through external current analysis.

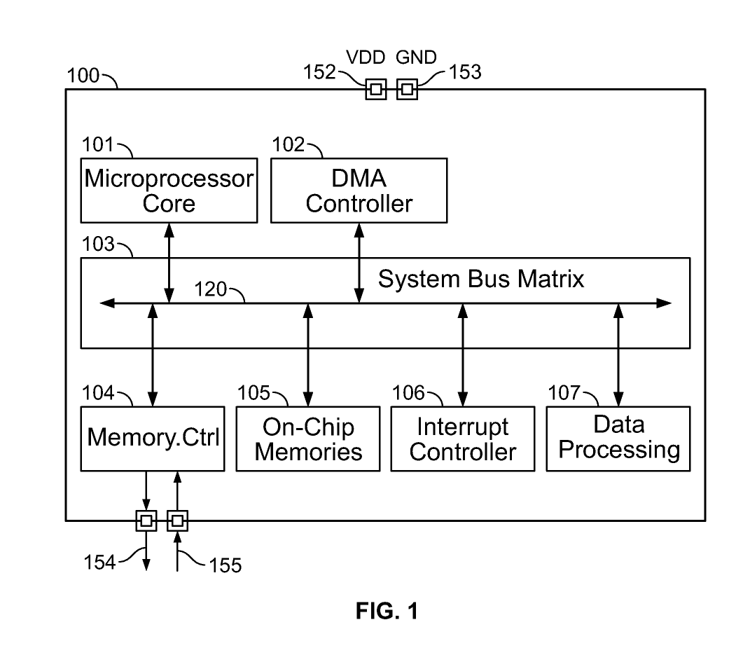

FIG. 1 is a block diagram of an example microcontroller 100 including a microprocessor core 101 and various modules 102, 103, 104, 105, 106 and 107 connected through a system bus matrix 103.

The modules can be configured to act as master modules on the system bus matrix 103 or slave modules. This interconnect may be implemented in the matrix module 103. Master modules can initiate data transfers with the slave modules on the system bus matrix 103. For the example microcontroller 100, a microprocessor core 101 and a standalone direct memory access (DMA) controller 102 are configured as master modules. A memory controller 104, on-chip memories 105, an interrupt controller 106, and a data processing module 107 are configured as slave modules.

The microcontroller 100 can communicate with external components through some of the modules. For example, the microcontroller 100 can communicate with a memory device using the memory controller 104. The modules may include terminal contact pads 154 and 155 to drive, or be driven by, external components, such as memory devices. The circuit 100 may be powered through terminal contact pads 152 and 153. The power consumption of the circuit can be determined by analyzing the current passing through these pad terminals.

The microprocessor core 101 is configured to execute code that includes executable instructions. The code is stored, for example, in the on-chip memories 105 or in an external memory accessed using the memory controller 104. In some implementations, the external memory is larger than the on-chip memory 105. For example, the external memory may be a flash memory storing user secret key information or data to be encrypted or decrypted.

The data processing module 107 receives data from any master modules (101 or 102) and performs processing and provides the resulting data to the master modules 101 or 102 through the system bus matrix 103. For example, data processing module 107 may be a digital signal processing function or core, an arithmetic coprocessor, an encryption/decryption engine, or a second microprocessor core. The module 107 can be a full synchronous logic circuit using counters, finite state machines, or other mechanisms.

### Generic Data Processing Module Architecture

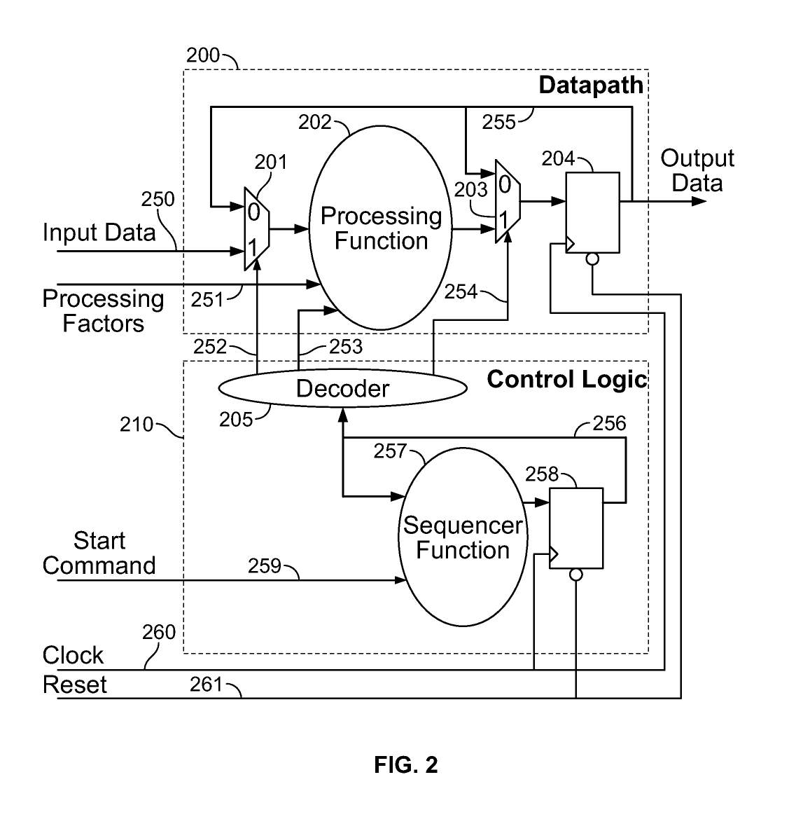

FIG. 2 is a block diagram of example data processing module architecture. For clarity, the combinational networks are not fully detailed in the generic architecture of FIG. 2. For example, for a digital synchronous counter, there is a combinational network feeding a set of DFFs. The combinational network is fed by the output of the DFFs, as illustrated by FIG. 2. A synchronous digital data processing module comprises a data path part 200 and a control part 210. The data path 200 receives data input 250 that may be recovered from the system bus by means of interface logic (not shown). The data input 250 feeds a data input of set multiplexers 201. For example, data input 250 may be used either to initialize the data processing with the input data 250 or to feed back the current state of processing into the data processing function. Data processing can be a standard encryption algorithm, such as a triple data encryption standard (Triple-DES) algorithm or advanced encryption standard (AES) algorithm. The output of multiplexer 201 drives the core 202 of the data processing function (FIG. 1, module 107). The complete data processing may take more than 1 clock cycle. Therefore, there is a need to store the actual intermediate result (output of 202) into a set of DFFs 204. The output of DFFs 204 is fed back into data processing core 202. When the data processing period ends, the resulting data must be stored and kept stable. The set of multiplexers 203 is used in association with set of DFFs 204 to act as a register. When the data processing period has elapsed, the multiplexers 203 select signal 255 and the data is re-circulated. As a consequence output data 255 carries the resulting data that can be read by any master module (FIG. 1, 101 or 102) by means of an interface circuit (not shown). For example, the data processing function can be configured by way of processing factors signals 251.

According to implementations, the multiplexers 201 and 203 may be driven by signals 252 and 254, respectively. The signals may be generated by control logic part 210. At the beginning (first clock cycle) of a data processing period, the signal 252 is asserted and the multiplexers 201 select input data signal 250 and drive this value into data processing function core part 202. Otherwise, feedback data may be provided. At the beginning, and while processing is in progress, signal 254 is also asserted so that the temporary resulting data (output of 202) may be stored into DFFs 204 for the next clock cycle. At the end of the data processing, signal 254 may be de-asserted and the processed data may be re-circulated to provide the resulting value.

According to implementations, control logic 210 may provide a sequencer function 257. For example, because control logic 210 is also a synchronous digital module, the control logic may be drawn using a generic architecture (e.g., a combinational network coupled to DFFs). These sequencers are often based on counters or finite state machines, which are digital synchronous circuits. For example, a counter can be used to generate a sequence which can be decoded to provide the required control signals of the datapath module 200.

According to implementations, a digital synchronous counter may comprise a set of DFFs 259 to store the current count value for the next clock cycle. For example, the DFFs may not perform any function but instead store the current count value. The sequencer function may be generated by the combinational network 257 placed in front of the DFFs 258. When implementing a counter, the main function is incrementing an input value by 1 (e.g., output=input+1) modulo N-bit. When the counter starts a new data processing period, the value of the counter can be cleared. To clear the counter, the combinational network can receive the command 259 which, when asserted, forces the output of the combinational network 257 to zero. Thus, the output signal 256 (the DFFs output) is cleared. When the signal 256 is cleared, the decoder logic 205 asserts both signal 252 and 254. When the counter value carried on signal 256 reaches a value corresponding to the end of the data processing period, the decoder logic 257 de-asserts signal 254.

During a data processing period, DFFs are switching simultaneously on the triggering edge of the clock. Not all DFFs are switching simultaneously on each triggering edge, thus, there may be a difference of consumption peak around each triggering edge of the clock.

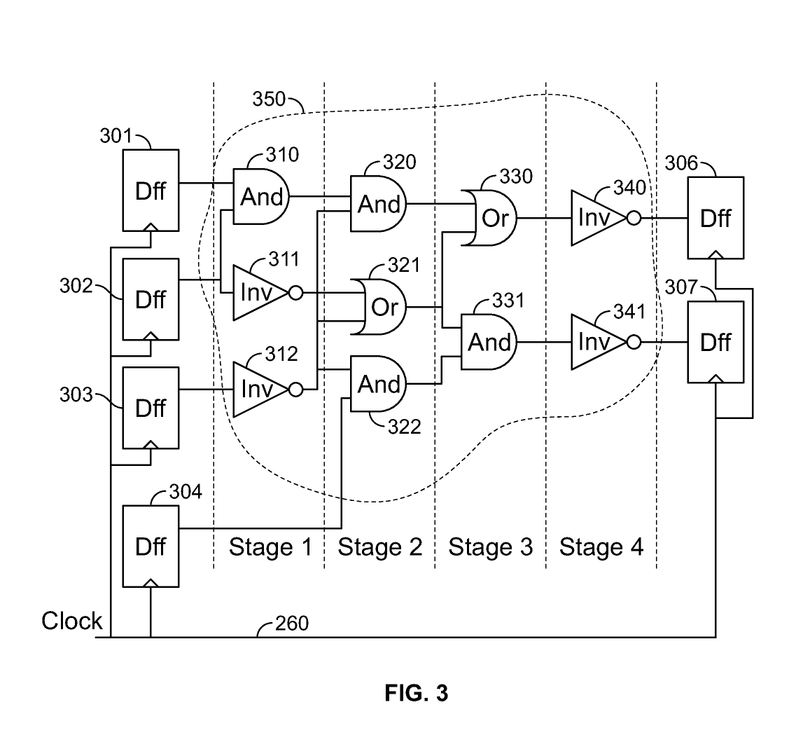

The combinational networks 202, 205 and 257 are also consuming power but each network may have a different power consumption curve based on their different internal structures. However, even if the functionality differs for each combinational network, the structure can be a set of combinational elements (OR, AND, inverter, etc.) organized in different layers and/or stages, as described further below with reference to FIG. 3. The number of layers and/or stages and the content of each layer and stage may be configured to produce a desired combinational function and may vary according to the desired function.

FIG. 3 is a block diagram of example combinational network architecture. FIG. 3 is presented by way of example and is not intended to illustrate a combinational architecture that provides any particular function. The combinational network 350 may be composed of a set of combinational elements 310, 311, 312, 320, 321, 322, 330, 331, 340 and 341. Each element has a propagation delay (input to output) depending on the type of the element and also on the capacitive load seen from the output pin of the element and other factors like the slopes of the signals connected to the input pins. When the clock signal triggers the DFFs 301-304, some DFFs outputs are simultaneously switching their output states. Therefore, there is a peak of current in the VDD/GND terminal. Then the first stage of combinational elements 310-320 is driven and some outputs switch later based on the propagation delay of the elements. For example, even if the propagation delays differ from one element to another element, the first stage power consumption curve may show a pulse of current. Subsequent stages may also show similar power consumption curve pulses.

Compared to current peaks due to DFFs switching, the current peaks for the combinational elements may be less because switching does not occur exactly at the same time over the clock cycle period. The peak current value of the DFFs is directly linked to the number of DFFs switching because for synchronous logic all of the clock pins of the DFFs are aligned (the clock tree is balanced). As a consequence, analyzing the current from outside of an integrated circuit may reveal internal details of the circuit. For example, by adding low value resistance on VDD or GND terminals and recording the current across the resistor the internal structure of the circuit may be determined.

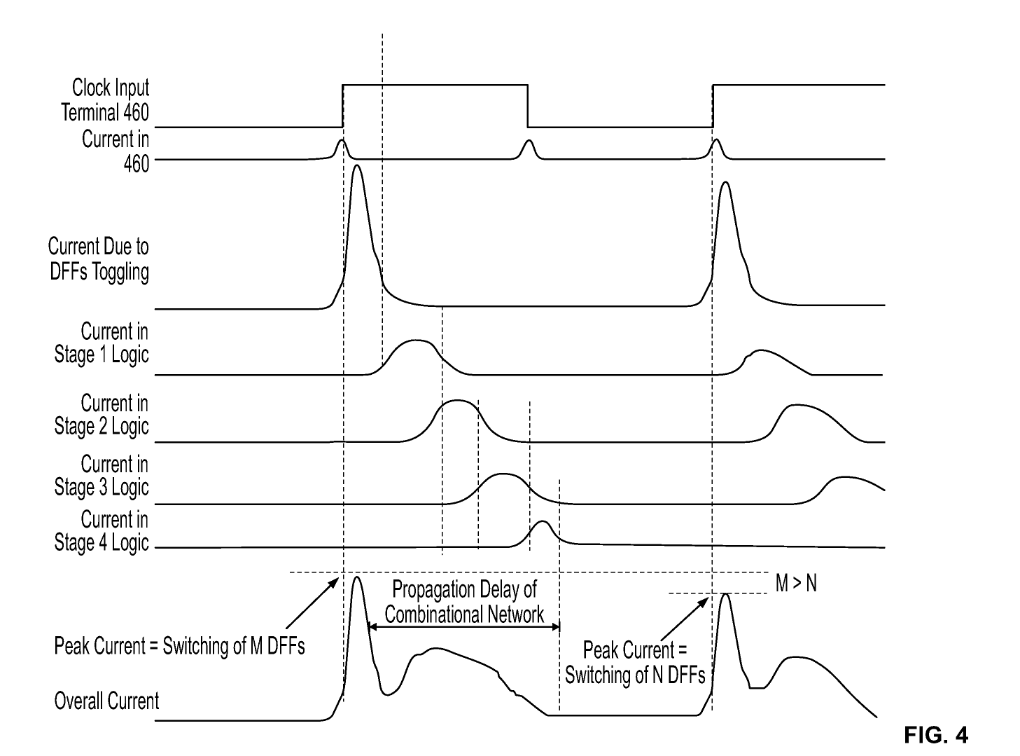

FIG. 4 is a line graph illustrating an example overall power consumption curve for the example circuitry of FIG. 2 within a microcontroller of FIG. 1. As seen in FIG. 4, the overall power consumption curve for the microcontroller is a series of double-pulses; one double-pulse for each triggering edge of the clock, for example. Each double-pulse may be composed of a short pulse of a high peak value (DFFs switching) and a smooth pulse that is the sum of the current used by all of the combinational elements. For example, the first part of a double-pulse may provide an indication of the number of DFFs that are simultaneously switching. Moreover, depending on the function being performed and the processing factors (refer to FIG. 2, function 202 and signal 251), one may be able to recover information carried on signal 251 by analyzing a large series of double-pulses. For example, this may be especially true if the function being performed is known and double-pulses are analyzed using differential power analysis.

According to implementations, the amount of information that can be deduced by external power analysis of a microcontroller may be reduced by including a circuit configured to keep constant the number of simultaneously switching DFFs regardless of the processing factors and/or the algorithm being processed. For example, one or more DFFs may be added into an existing predetermined logic to keep the number of simultaneously switching DFFs constant.

According to implementations, a digital circuit is added to a predetermined logic that adds one DFF for one DFF of the predetermined logic. For example, if the DFF of the predetermined logic is about to switch on the next triggering edge of the clock, the added DFF is forced in its previous state. If the predetermined logic DFF is not going to switch, the added DFF will toggle its output value.

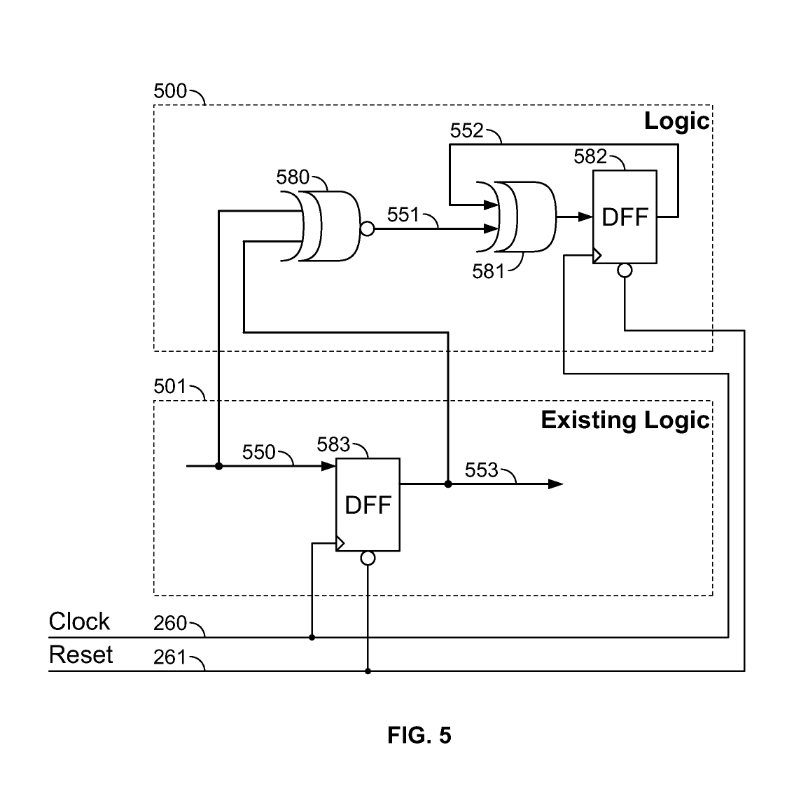

FIG. 5 is a block diagram of an example circuit including an example current uniformization logic coupled to existing predetermined logic. Current uniformization logic circuitry 500 is coupled to predetermined logic 501. If DFF 583 is about to switch on the next triggering edge of clock 260, its data input 550 differs from its output 553. If DFF 583 is not about to switch on the next triggering edge of clock 260, the input 550 to DFF 583 is equal to its output 553. If input 550 and output 553 are equal, the XNOR cell 580 asserts signal 551. The signal 551 drives one input of XOR cell 581. Thus, no matter what the value carried on signal 552 is, which corresponds to the output of DFF 582, the output of the XOR gate 581 is the opposite of signal 552. For example, the output of the XOR gate 581 is the opposite of the state of DFF 582; if DFF 583 is not switching, DFF 582 switches.

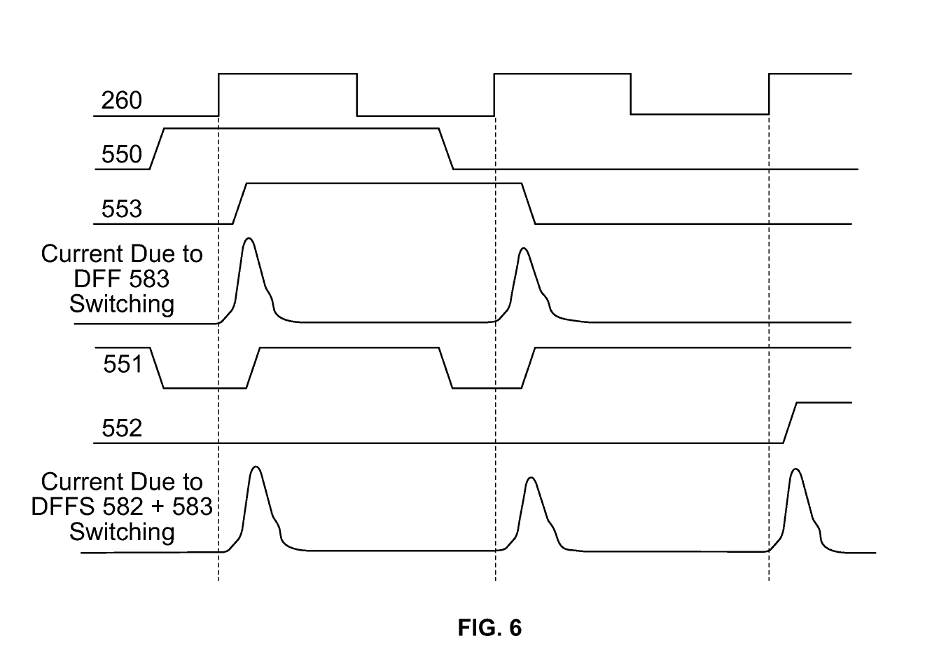

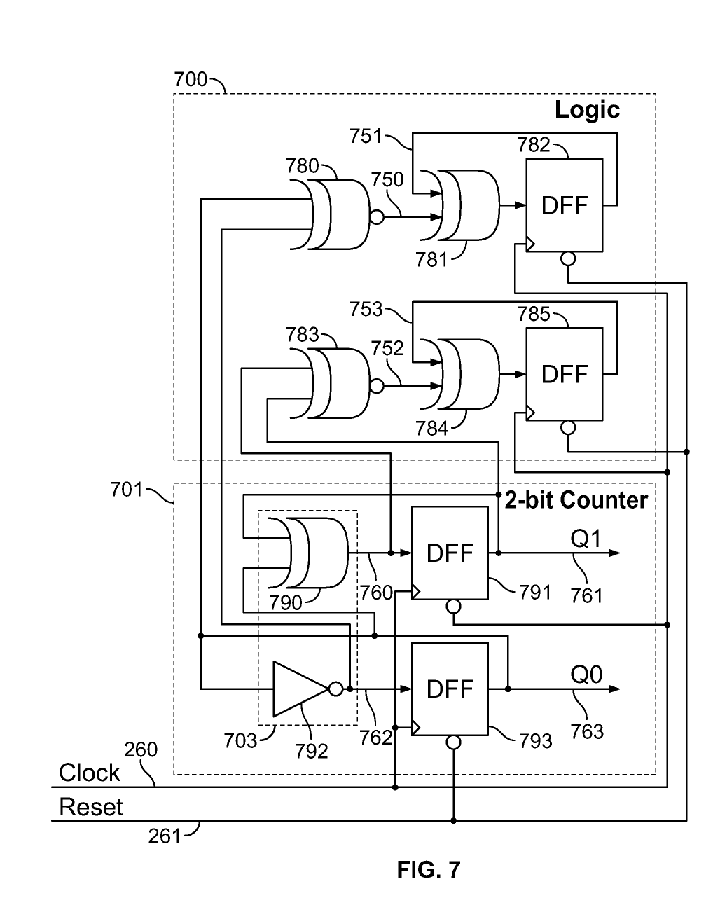

FIG. 6 is a line graph of an example overall power consumption curve for a circuit that includes current uniformization logic. As illustrated by FIG. 6, the circuit described with reference to FIG. 5, above, produces a power consumption curve that shows one DFF switch for each triggering edge of the clock 260. This behavior may also be observed when the uniformization circuit is applied to the basic 2-bit binary counter of FIG. 7.

FIG. 7 is a block diagram of an example circuit including a 2-bit binary counter coupled to example current uniformization logic. For example, a free running 2-bit binary counter 701 is coupled to uniformization logic 700. According to implementations disclosed herein, uniformization logic 700 may include one DFF for each DFF included in 2-bit counter 701. For example, the 2-bit counter 701 may be implemented as a set of DFFs coupled to a combinational network. The 2-bit counter may be composed of 2 DFFs 791 and 793 driven by a combinational network 703. The combinational network may perform the following: output=(input+1) modulo 4, where input and output are 2 bits wide. The input signals are signals 761 and 763. The output signals are signals 760 and 762. While additional details of the combinational network are illustrated in FIG. 7, they are not useful for explaining the implementations disclosed herein.

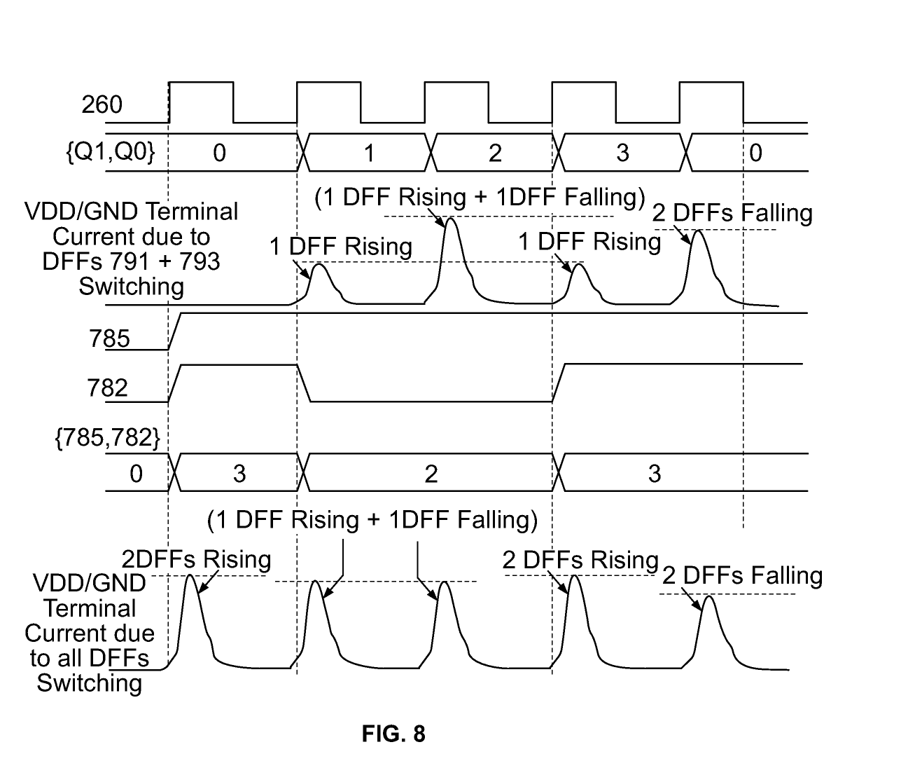

According to implementations, the uniformization logic 700 is coupled to each DFF of the predetermined logic 701. For example, DFF input and output of module 701 is sent to module 700. If a DFF from module 701 is not going to switch on the next triggering edge of the clock 260, then a DFF from module 700 is going to toggle. Thus, the overall number of DFFs switching is two whatever the 2-bit counter value may be. Compared to FIG. 5, there is a duplication of the basic uniformization logic circuitry for each DFF. For example, in module 701, there is a different number of DFFs switching in a simultaneous way at each triggering edge of the clock 260 depending on the counter values. This feature is detailed in FIG. 8.

FIG. 8 is a line graph of an example overall power consumption curve for a circuit that includes current uniformization logic, such as the circuit of FIG. 7. For example, when the 2-bit counter state changes from 0 to 1, only the LSB changes, carried by DFF 793 and propagated along signal 763. As illustrated by FIG. 8, there is one current peak due to a rising edge on the output of DFF 793. When the counter state value changes from 1 to 2, one DFF is switching from 1 to 0 (LSB generated by DFF 791 and carried along signal 763) while the other DFF is switching from 0 to 1 (MSB generated by DFF 793 and carried along signal 761). The current from both DFFs accumulates in a higher peak compared to the first state change from 0 to 1.

Furthermore, when the counter state changes from 2 to 3, only one DFF switches from 0 to 1 (LSB generated by DFF 791 and carried along signal 763). When the counter state changes from 3 to 0, two DFFs switch from 1 to 0. As illustrated by FIG. 8, the overall peak of current accumulates into the VDD/GND terminal to produce a higher pulse peak as compared to the previous pulse and produces a pulse peak close to the pulse created when switching from 1 to 2. However, the pulse peak observed when switching from 3 to 0 may be slightly different than the pulse peak observed when switching from 1 to 2 because there are two falling edges when switching from state 3 to state 0 compared to one falling and one rising edge when switching from state 1 to state 2. This difference may be explained by the difference in p-channel metal-oxide-semiconductor (PMOS) and n-channel MOS (NMOS) transistors in the complimentary MOS (CMOS) logic of DFF architecture, for example. As a consequence, it may be easy to locate the internal state of the 2-bit binary counter by analyzing the current passing through the VDD/GND terminals.

According to implementations, the current uniformization logic may make determining the internal state of the counter more difficult. For example, if the 2-bit binary counter is in state 0, there is no power consumption (no pulses). When the counter starts, pulses start to appear. Thus, the time that a counter starts may be easily determined. When the current uniformization logic is added to the 2-bit binary counter, even a counter in state 0 exhibits DFF switching. With reference to FIG. 7 and FIG. 8, if the 2-bit binary counter is maintained at state 0 (i.e., signal 761=0 and signal 763=0) the DFFs 782 and 785 are switching because signals 750 and 752 are asserted thereby generating a toggle value at the outputs of XOR gates 781 and 784, for example. Thus, implementations disclosed herein generate current pulses no matter what state of the 2-bit counter is.

Moreover, the peak current of the 2-bit counter implemented with the uniformization logic does not differ much from one clock cycle to the next because there is a constant number of DFFs switching at each clock cycle, according to implementations. However, there may be some differences between the peak values due to the inherent architecture of the DFFs and also due to their different capacitive loads. For example, DFF 761 may drive 2 capacitive loads (1 input of 703 and 1 input of XOR 783) whereas DFF 763 may drive 3 capacitive loads (2 inputs of 703 and 1 input XOR 780). However, these differences in peak values are very limited and include the additional logic switching so it is much more difficult to determine what is going on inside of the circuit. This is especially true when a uniformization logic circuit is applied to a module that has a large number of DFFs (not limited to one or two), for example. According to implementations, the uniformization logic circuit can be applied either in the datapath part or the control logic part of a circuit module, such as module 107 of FIG. 1.

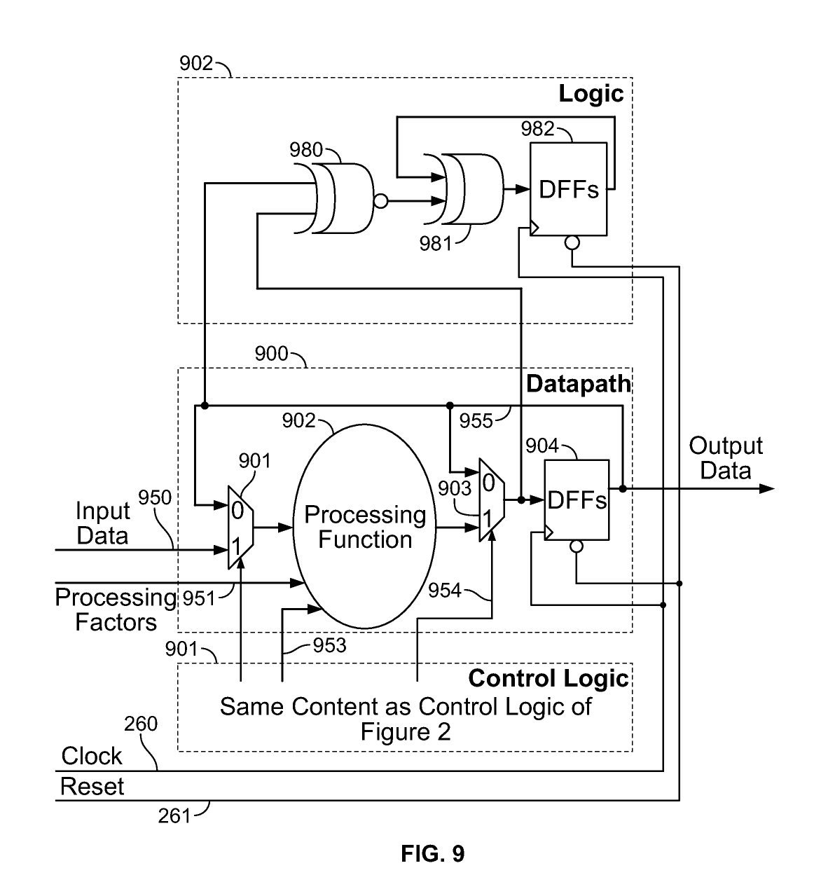

FIG. 9 is a block diagram of an example data processing module including current uniformization logic. All signals are considered as vectors in the schematic of FIG. 9. According to implementations, uniformization logic 902 may be coupled to datapath 900 of a data processing module, such as data processing module 107 of FIG. 1. According an implementation, the difference in peak values observed in a circuit may be reduced if the circuitry of FIG. 9 is manufactured with a library containing DFFs having high to low and low to high propagation delays that are equal. Moreover, each additional DFF must drive the same load as the DFF being supervised to reduce the differences in peak values as much as possible.

According to implementations, uniformization logic circuits may be designed to include DFFs having parasitic capacitance that matches the parasitic capacitance of DFFs contained in a corresponding predetermined logic. For example, when designing a circuit that includes the uniformization logic disclosed herein, as soon as the predetermined logic is created, it is possible to extract or calculate the parasitic capacitance (including the wire load) of the output of any DFF and to couple enough combinational cells on the output of the additional DFF to match this parasitic capacitance. The connected cells can be any combinational cell because just the input of the cell is coupled to the output of the additional DFF and the output of the combinational cell will remain uncoupled. Both the uniformization logic circuitry insertion process and the capacitance matching process can be automated by computed aided design tools.

In some implementations, a logic synthesis tool, place and route tool or other software tool can implement the uniformization logic circuitry as described in reference to FIGS. 5-9. A method of synthesizing uniformization logic circuitry can include analyzing circuitry to identify sequential elements. For each identified sequential element, adding a new sequential element having a data input that is configured to toggle when a data output of the identified sequential element is not going to switch. An instruction to toggle can be implemented by coupling additional combinational logic elements in the circuitry. For each identified sequential element, the overall capacitance driven by the sequential element can be calculated and/or extracted and an additional length of wire and/or a number of elements can be connected to the additional sequential elements to match the calculated/extracted capacitance of the identified sequential element.

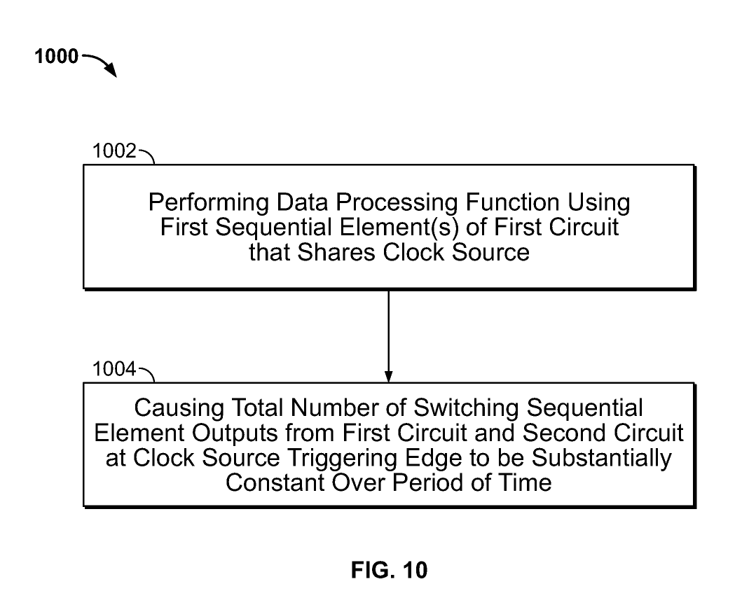

FIG. 10 is a flow diagram of an example process 1000 for providing uniform power consumption in a microcontroller. In some implementations, the process 1000 can begin by performing a data processing function using one or more first sequential elements of a first circuit that share a clock source (1002). The process continues by causing a total number of switching sequential element outputs from the first circuit and a second circuit at the clock source triggering edge to be substantially constant over a period of time (1004).

While this document contains many specific implementation details, these should not be construed as limitations on the scope what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

What is claimed is:

1. An integrated circuit comprising
a first circuit configured to perform a predetermined function, the first circuit including one or more first sequential elements that share a clock source;
a second circuit coupled to the first circuit, the second circuit including one or more second sequential elements driven by the clock source, where the one or more second sequential elements are configured to cause a total number of switching sequential element outputs from the first and second circuit at the clock source triggering edge to be substantially constant over a period of time.

2. The circuit of claim 1, wherein the one or more second sequential elements are forced to switch outputs so that the total number of switching sequential element outputs is constant over the period of time.

3. The circuit of claim 1, where the sequential elements are data flip-flops.

4. The circuit of claim 1, where the first and second circuits include synchronous digital logic.

5. The circuit of claim 1, where the number of sequential elements of the first and second circuits differ.

6. The circuit of claim 1, where a sequential element data input of the second circuit is driven by one or more combinational elements which are configured to:
detect whether there is a logical value difference between the sequential element data input and a sequential element data output of the first circuit;
create a change in a data output of a sequential element of the second circuit when there is a difference between data input and data output of the first circuit sequential element; and
prevent a change in the data output of the sequential element of the second circuit when there is not a difference between data input and data output of the first circuit sequential element.

7. The circuit of claim 6, where the combinational elements are Exclusive OR (XOR) gates.

8. The circuit of claim 1, where the first and second circuits are coupled to a microprocessor through a system bus.

9. The circuit of claim 8, wherein the first circuit is configured to perform data encryption or decryption.

10. The circuit of 9, wherein the first circuit is configured to performing a standard algorithm for encryption.

11. The circuit of claim 10, wherein the first circuit is configured to perform a triple data encryption standard (Triple-DES) algorithm or advanced encryption standard (AES) algorithm.

12. The circuit of claim 1 where the circuit is part of a microprocessor or microcontroller.

13. The circuit of claim 12 where the microprocessor or microcontroller is configured to execute instructions on 1 clock cycle period.

14. A method comprising
performing a data processing function using one or more first sequential elements of a first circuit that share a clock source; and
causing a total number of switching sequential element outputs from the first circuit and a second circuit at the clock source triggering edge to be substantially constant over a period of time.

15. The method of claim 14, further comprising:
forcing the one or more second sequential elements to switch outputs so that the total number of switching sequential element outputs is substantially constant over the period of time.

16. The method of claim 14, where the sequential elements are data flip-flops.

17. The method of claim 14, where the first and second circuits include synchronous digital logic.

18. The method of claim 14, where the number of sequential elements of the first and second circuits differ.

19. The method of claim 14, further comprising:
driving a sequential element data input of the second circuit by one or more combinational elements which are configured for:
detecting whether there is a logical value difference between the sequential element data input and a sequential element data output of the first circuit;
creating a change in a data output of a sequential element of the second circuit when there is a difference between data input and data output of the first circuit sequential element; and
preventing a change in the data output of the sequential element of the second circuit when there is not a difference between data input and data output of the first circuit sequential element.

20. The method of claim 14, wherein performing a data processing function further comprises:
performing data encryption or decryption.
